(19) United States
(12) Patent Application Publication
(10) Pub. No.: US 2010/0136170 A1
(43) Pub. Date: Jun. 3, 2010

(54) Procedure for Extruder Cooking of Animal Feed Without Using a Dryer

(76) Inventor: Dan Oudal Edberg, Kolding (DK)

Correspondence Address: JAMES C. WRAY, 1493 CHAIN BRIDGE ROAD, SUITE 300, MCLEAN, VA, 22101, US

(21) Appl. No.: 12/085,812

(22) PCT Filed: Oct. 24, 2006
(86) PCT No.: PCT/DK2006/005992

§ 371 Date: Jun. 23, 2008

(30) Foreign Application Priority Data
Nov. 30, 2005 (DK) PA 2005 01684

(51) Int. Cl. A23L 1/0522; A23P 1/12

(52) U.S. Cl. 426/61; 426/464; 426/578

(57) ABSTRACT

Procedure for production of dry feeds for animals without using a drier by adding 25% of a digestible starchy or another extrudable powdery “glue” to a continuous extruder cooker, where it is cooked at high pressure and temperature until sufficient gelatinization and thermo-plastic condition is achieved. The glue product is then carried through a vacuum zone, in which the sudden pressure drop causes evaporation and temperature drop, so that the moisture content in the glue product drops. After the vacuum zone 75% of an unheated primary feed mixture is added to the glue product, and the two products are mixed. After the mixing zone the finished product is carried through a die and cut to pellets by a rotating knife.

### THE INVENTION CONCERNS

The invention concerns a procedure for extruder cooking of animal feed without using a drier.

Compared to the extruder cooking process used today it is avoided to use a hot air drier, which is the most common drying process in connection with extruder cooking of animal feed, and which causes large environmental odour problems, has a high energy consumption and requires large plant investments.

The procedure consists of addition of max. 25% of a digestible starchy or another extrudable powdery “glue” to a continuous extruder cooker, in which the glue product and added water, if any, are mixed and extruder cooked at high pressure and temperature, until sufficient gelatinization and thermo-plastic condition has been achieved. Subsequently the glue product is carried through a vacuum zone, where the sudden pressure drop causes evaporation and temperature drop, so that the moisture content in the glue drops. After the vacuum zone a minimum of 75% of a primary feed mixture is added—unheated—at so low moisture content, that the moisture content of all raw materials, plus the added water quantity of the glue product minus the evaporated moisture quantity in the vacuum zone, minus evaporated water quantity after the die and minus evaporated water quantity over the cooler is lower than the desired moisture quantity of the finished product.

The glue product and the primary feed mixture is carried through a mixing zone, in which the two products are mixed homogeneously to a finished product. After the mixing zone, the finished product is carried through a die at rising pressure and temperature out to atmospheric pressure. The sudden pressure drop causes evaporation and temperature drop, so that the moisture content of the finished product drops. After the die a rotating knife cuts the pellets at suitable length. The finished product is carried through a cooler, which cools the finished product to ambient temperature, which results in evaporation, so that the moisture content of the finished product drops. The finished product is now ready to be stored.

### Stage of Technology:

Today continuous extruder cooking of animal feed takes place in a process, which consists of the following process steps:
Production of a powder mixture
   (Grinding and mixing).
Pre-conditioning of the powder mixture.
   (Heating, water addition and retention time).
Extruder cooking of the powder mixture.
   (Water addition, mixing, continuous cooking at high pressure and pelletizing)
Air-drying of pellets
   (Removal of moisture to allow storage, normally approx. 90° C. hot air into a drier is used).
Air-cooling of pellets
   (Cooling from drying temperature to storage temperature, to avoid condensate, normally cooling air at ambient temperature is used.)

The cooler and drier are often built together as a unit, in which the heated cooling air is used as pre-heated drying air. A hot-air cooler is defined by using hot air at a temperature above 50° C.

The largest disadvantage of the above extruder cooker process is drying. The warm, moist and often oily drying air causes environmental odour problems, is highly energy demanding and requires large plant investments.

The moisture content of the powder mixture to be extruder cooked should typically be

20-30% to make the starch of the powder mixture gelatinize and form the glue, which can bind the powder mixture into a pellet.

The moisture content of the finished product should typically be between 8-12%, which means that typically 10-15% moisture should be dried, depending on the kind of product to be produced.

The capacity of a typical extruder cooker for animal feed is approximately 10 tph, which means that between 1 and 1.5 tph moisture should be removed. A hot air drier for 10 tph, which should remove 1.5 tph moisture, requires approximately 15,000 m³, 90° C. heated process air per hour.

At exit from the drier this process air is approximately 50° C. warm, moist, dust laden, oily and emits so much odour, that a cleaning plant is necessary. Especially extruder-cooked fish feed production causes large odour problems, and consequently very large investment in cleaning plants.

Patent No. EP1223817 describes a procedure for production of feed encapsulated in a digestible shell, which can fulfil the wish to avoid drying and reduce energy consumption. The problem with this procedure is that in practice the encapsulated block cannot be smaller than 30×30×30 mm, and the capacity is very low.

The shape requires another infrastructure and logistics than the existing, and consequently it is not realistic.

U.S. Pat. No. 5,480,673 describes a procedure for extruder cooking of high-resolution proteins by dividing the powder mixture into a starch part and a protein part. The finished product contains so much moisture, that drying is necessary.

Patent No. EP 1342548 A1 describes a procedure for extruder cooking of a product with controlled release of an encapsulated product. The finished product contains so much moisture, that drying is necessary.

### The Special Effect Gained Compared to the Stage of Technology:

It has been the goal of the invention to find an alternative extruder cooking process for animal feed without drying.

FIG. 1.0 shows a functional diagram with an example of an extruder cooking process, which meets the desired properties. A digestible starchy glue product is fed to the first extruder cooker extruder head (may be heated by steam), in which water or steam can also be added, if the moisture content of the glue product is not sufficiently high. Glue and water are mixed.

The extruder screw now carries the glue product through a cooking zone, in which the glue product under high pressure and retention time is heated to the temperature, which is required to make the starch gelatinize and form a thermo-plastic condition.

The pressure increase is obtained by forming resistance during screw conveyance and by heating of the extruder heads, if required.

The glue product is now carried on through a vacuum zone, in which the pressure immediately drops to atmospheric pressure or lower, and consequently there is sudden evaporation and drops in the moisture content and temperature of the glue product.

The glue product is now carried on through an intake zone, in which the primary mixture is added.

Upon addition of the primary mixture to the glue product, the two materials are carried through a mixing zone, and a finished product is formed.

The finished product is pressed through a die, in which the size and shape of the pellet is determined, and a rotating knife placed after the die determines the length of the pellet.

When the finished product is pressed through the die, the pressure rises before the die and drops immediately to atmospheric pressure after the die, and consequently there is sudden evaporation and drops in the moisture content and temperature of the finished product.

Hereafter the pellets are conveyed to a cooler, in which further evaporation and reduction of the moisture content of the finished product takes place, whereupon the finished product is ready for storage.

The moisture content after the extruder cooking process, i.e. the finished product after cooling depends on the following parameters:

1. The moisture content of all raw materials
2. The water quantity added to the glue product
3. Process evaporation

A certain primary feed mixture required a minimum glue product, and consequently a minimum water addition to the glue product to achieve the ideal moisture content of 25-35%, depending on the glue product used.

The above proportion consequently determines, how high the moisture content of the primary feed mixture must be.

If the moisture content of the primary feed mixture is low, more water can be added to the glue product to get a finished product with approximately 12% water.

Normally, the cooling process will remove approximately 2% moisture and thus allow 14% moisture content in the finished product after the extruder cooker, if the maximum moisture content of the cooled finished product is 12%.

There is no problem in getting raw materials with the desired moisture content for the primary feed mixture.

As the glue product makes up to 25% and often 10-20% of the finished product, pre-conditioning is not necessary.

The pre-conditioning process requires much energy, large plant investments and a high building height. The invention can have great importance for existing extruder cooking plants with air driers, as much larger extruder cooker capacity can be installed in connection with switch-over to the new process, without the existing air drier becoming a limitation and without increased odour emission.

With the new process the existing air drier can be used as air cooler and thus increase the existing cooler capacity.

Existing fish feed plants are often placed in areas, where odour emission must not be increased, and therefore the new process can be a way for these plants to increase capacity.

### The Means Used to Achieve the Special Effect of the Invention

The special effect according to the invention is achieved by a procedure of the kind initially mentioned and is characterized by the fact, that the extruder cooking process takes place without the use of a drier, and that the primary feed mixture has so low moisture content, that the moisture content of all raw materials plus the water quantity added to the glue product minus the moisture quantity evaporated in the vacuum zone, minus the moisture quantity evaporated after the die and minus the moisture quantity evaporated over the cooler is lower than the desired moisture content of the finished product.

### Mode of Operation of the Procedure:

In a continuous extruder cooker a digestible starchy or another extrudable powdery glue product is carried to an intake zone.

Water is added to the glue product, if the moisture content is not sufficient to gelatinize the starch.

Any water added and the glue product are mixed to a homogeneous mixture in a mixing zone.

The glue product is carried through a cooking zone at high pressure and temperature until sufficient gelatinization and thermo-plastic condition has been achieved.

The glue product is carried through a vacuum zone, where the pressure is suddenly reduced to atmospheric pressure or lower, which results in evaporation of the moisture content of the glue product and consequently a reduction of temperature.

The glue product is carried to an intake zone, in which the primary feed mixture is added. The glue product and the primary feed mixture is carried through a cooling zone and through a mixing zone, in which the glue product and the feed mixture is mixed to a homogeneous finished product.

The primary feed mixture shall as a minimum constitute 75% in proportion to the glue product. At such high quantities of the primary feed mixture there is risk of backlash in the extruder, so that the finished product blocks up for dosing of the primary feed mixture.

The distance from the dosing of the primary feed mixture to the extruder die must consequently be so long that backlash is avoided.

After the mixing zone the finished product is pressed through a die, in which: the desired pellet size and shape are formed.

When the finished product is cooled, a hard product ready for storage is formed.

### Comment to Claim 2:

In a special execution the vacuum zone is not established. If the primary feed mixture has very low moisture content, the vacuum zone is not necessary.

### Comment to Claim 3:

In a special execution the process is performed with separate machines for one or more process zones.

### Comment to Claim 4:

The primary feed mixture can contain any form of feedstuffs or mixtures thereof in any mixing proportion, liquid, paste-like as well as powdery.

### Comment to Claim 5:

The glue product can contain any form of feedstuffs or mixtures thereof in any mixing proportion, liquid, paste-like as well as powdery; decisive is that the mixture can be extruder cooked and form glue.

### Comment to Claim 6:

The primary feed mixture can contain any form of flavour and aroma additives or mixtures thereof in any mixing proportion. Flavour and aroma additives can improve animal feed acceptance.

As the primary feed mixture is not heated, matters, which cannot withstand heating, can be used, and no loss of properties will occur due to heating.

### Comment to Claim 7:

The glue product can contain any form of flavour and aroma additives or mixtures thereof in any mixing proportion. Flavour and aroma additives can improve animal feed acceptance.

### Comment to Claim 8:

The primary feed mixture can contain any form of vitamins, additives and minerals or mixtures thereof in any mixing proportion.

As the primary feed mixture is not heated, matters, which cannot withstand heating, can be used, and no loss of properties will occur due to heating.

### Comment to Claim 9:

The primary feed mixture can contain any form of functional matters or mixtures thereof in any mixing proportion.

As the primary feed mixture is not heated, it will be possible to use matters, which do not withstand heating, and many functional matters cannot withstand heating.

### Comment to Claim 10:

The primary feed mixture can contain any form of pharmaceutical matter or mixtures there of in any mixing proportion.

As the primary feed mixture is not heated, it will be possible to use matters, which do not withstand heating, and many pharmaceutical functional matters cannot withstand heating.

### Comment to Claim 11:

The primary feed mixture can contain any form of pH-lowering matters or mixtures thereof in any mixing proportion. The purpose of pH-lowering matters is to conserve the feed.

### Comment to Claim 12:

The primary feed mixture can contain any form of substance, which can form chemical reaction with the feed mixture or mixtures thereof in any mixing proportion.

### Comment to Claim 13:

The primary feed mixture can contain a hide or skin improving matter.

### Comment to Claim 14:

The primary feed mixture can contain anti-inflammatory enhancing matters.

### Comment to Claim 15:

The primary feed mixture can contain antioxidant-enhancing matters.

### Comment to Claim 16:

The primary feed mixture can contain respiration-enhancing matters.

### Comment to Claim 17:

The primary feed mixture can contain immune defense enhancing matters.

### Comment to Claim 18:

The primary feed mixture can contain anti-parasite enhancing matters.

### Comment to Claim 19:

The primary feed mixture can contain pre-biotic or pro-biotic matters.

### Comment to Claim 20:

The procedure can be used for food for human consumption.

### Comment to Claim 21:

The procedure can use a cooler, which has a cooling air temperature between 0° C. and 60° C.

### Comment to Claim 22:

The procedure means that an existing air drier in an existing extruder cooler plant can be utilized as air cooler and together with the existing air cooler it can increase the cooling capacity and consequently the capacity of the extruder cooking plant.

### FIGURE INDEX

FIG. 1.0 shows the temperature and pressure progress in the extruder and the moisture content during the various process phases.

### DETAILED EXPLANATION OF WHAT IS SHOWN IN THE DRAWING

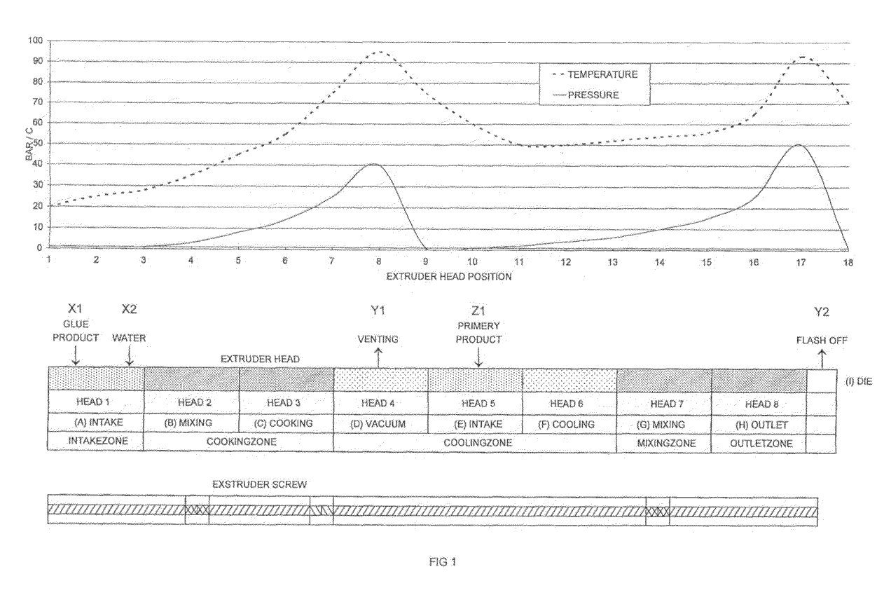

FIG. 1.0 shows a temperature and pressure diagram, in which the temperature and pressure progress in principle is shown in relation to the extruder cooker position; further the moisture content of the product in relation to the process progress is shown.

An extruder cooker consists of an extruder head, in which an extruder screw is rotating. The head and screw is often divided into a suitable number of segments, so that the head and screw can be configured to a specific job.

At the intake zone (A) (the rear extruder end) the glue product X1 (e.g. wheat) is added.

The glue product can be added at room temperature or it can be preheated and moistened by steam before addition.

If the glue product does not have sufficient moisture to gelatinize the starch (25-35%) at addition into the intake zone (A), water or steam (X2) must be added, and mixing must take place immediately upon introduction.

If water is added, the glue product and water is carried through a mixing zone (B), in which glue product and water are mixed homogeneously.

From the mixing zone (B) the glue product is carried to the cooking zone (C), in which a′ high pressure is built up be forming a counter-pressure from the extruder screw and heating the extruder head to promote the cooking process, if necessary.

From the cooking zone (C) the glue product is carried to the vacuum zone (D), in which the pressure immediately drops to atmospheric pressure or lower (1) with sudden evaporation and drop in the moisture content and temperature of the glue product as consequence.

From the vacuum zone (D) the glue product is carried through the intake zone (E), in which the primary feed mixture is added.

As a minimum the primary feed mixture must be 75% of the mixture of glue product and the primary feed mixture to keep the total moisture as low as possible (below 12%).

From the vacuum zone the two products are carried through a cooling zone (F) for further cooling and prevention of product backlash into the intake zone (E). From the cooling zone (F) the glue product and the primary feed mixture is carried through a mixing zone (G), in which the two products are mixing homogeneously to a finished product.

From the mixing zone (G) the finished product is carried through an outlet zone (H), which prevents backlash to the mixing zone (G) and to a die, in which pressure increase takes place through the die.

After the die the pressure drops immediately to atmospheric pressure resulting in sudden evaporation (Y2) and drop in the moisture content and temperature of the finished product.

The moisture content of the glue product is of no importance, as in any case it must be supplemented up to 25-35%, depending on which glue product is used.

The moisture content of the primary feed mixture must not exceed the moisture content desired in the finished product.

If a glue product requires much water to gelatinize starch, the moisture content of the primary feed mixture can be adjusted, so that the finished product gets the desired moisture content.

From the extruder cooker the finished product (A) bypasses the cooler (XX) directly to the cooler (YY), in which the finished products (B and C) are cooled to storage temperature. During cooling up to 2% moisture is normally removed.

1. Procedure for production of dry feed for animals without the use of a drier by (A) introduction of max. 25% digestible starchy or another extrudable powdery “glue” to a continuous extruder cooker, in which the glue product and (B) moisture added, if necessary, are mixed and (C) extruder cooked at high pressure and temperature, until sufficient gelatinization and thermo-plastic condition has been achieved.
Subsequently the glue product is carried through a (D) vacuum zone, in which the sudden pressure drop causes evaporation and temperature drop, so that the moisture content of the glue product drops. Characterized in that after the vacuum zone (E) 75% of unheated primary feed mixture at low moisture content is added to the glue product as a minimum, and the two products are carried through the cooling zone (F) for further cooling. After the cooling zone (F) the glue product and the primary feed mixture is carried through a mixing zone (G), in which the two products are mixed homogeneously to a finished product. After the mixing zone the finished product is carried through a die (I) at rising pressure and temperature out to atmospheric pressure. The sudden pressure drop causes evaporation and temperature drop, so that the moisture content of the finished product drops. After the die a rotating knife cuts the pellets to suitable length. The finished product is carried through a cooler, which cools the finished product to ambient temperature, whereby evaporation takes place, so that the moisture content of the finished product drops.

2. Procedure according to claim 1, characterized in that the vacuum zone (D) is not established.

3. Procedure according to claim 1, characterized in that a special execution executes the process with separate machines for one or more of the part processes.

4. Procedure according to claim 1, characterized in that the primary feed mixture can contain any form of feedstuffs or mixtures thereof in any mixing proportion, liquid, paste-like as well as powdery.

5. Procedure according to claim 1, characterized in that the glue product can contain any kind of feedstuffs or mixtures thereof in any mixing proportion, liquid, paste-like as well as powdery. Decisive is that the mixture can be extruder cooked and form a glue.

6. Procedure according to claim 1, characterized in that the primary feed mixture can contain any kind of flavour and aroma additives or mixtures thereof.

7. Procedure according to claim 1, characterized in that the glue product can contain any kind of flavour and aroma additives or mixtures thereof.

8. Procedure according to claim 1, characterized in that the primary feed mixture can contain any kind of vitamins, additives as well as minerals or mixtures thereof.

9. Fremgangsmåde if526 lge krav 1, characterized in that the primary feed mixture can contain any kind of functional matters or mixtures thereof.

10. Procedure according to claim 1, characterized in that the primary feed mixture can contain any kind of pharmaceutical matters or mixtures thereof.

11. Procedure according to claim 1, characterized in that the primary feed mixture can contain any kind of pH-lowering matters or mixtures thereof.

12. Procedure according to claim 1, characterized in that the primary feed mixture can contain any form of matters which can form chemical reaction with the feed mixture or mixtures thereof.

13. Procedure according to claim 1, characterized in that the primary feed mixture can contain hide or skin enhancing matter.

14. Procedure according to claim 1, characterized in that the primary feed mixture can contain an anti-inflammatory enhancing matter.

15. Procedure according to claim 1, characterized in that the primary feed mixture can contain antioxidant-enhancing matters.

16. Procedure according to claim 1, characterized in that the primary feed mixture can contain respiration-enhancing matters.

17. Procedure according to claim 1, characterized in that the primary feed mixture can contain immune defense enhancing matters.

18. Procedure according to claim 1, characterized in that the primary feed mixture can contain anti-parasite-enhancing matters.

19. Procedure according to claim 1, characterized in that the primary feed mixture can contain pre-biotic or pro-biotic matters.

20. Procedure according to claim 1, characterized in that the procedure can be used for foods for human consumption.

21. Procedure according to claim 1, characterized in that the procedure can use a cooler, in which the cooling air temperature lies between 0° C. and 60° C.

22. Procedure according to claim 1, characterized in that an existing air cooler in an existing extruder cooker plant can be utilized as air cooler together with an existing air cooler.
